(19) United States
(12) Patent Application Publication
(10) Pub. No.: US 2015/0028231 A1
(43) Pub. Date: Jan. 29, 2015

(54) LASER APPARATUS

(71) Applicant: GIGAPHOTON INC, Oyama-shi (JP)

(72) Inventors: Hakaru MIZOGUCHI, Oyama-shi (JP); Osamu WAKABAYASHI, Oyama-shi (JP)

(21) Appl. No.: 14/455,685

(22) Filed: Aug. 8, 2014

Related U.S. Application Data
(63) Continuation of application No. PCT/IB2012/002780, filed on Dec. 21, 2012.

(30) Foreign Application Priority Data
Mar. 27, 2012 (JP) 2012-072588

(51) Int. Cl. H05G 2/00; H01S 3/223; H01S 3/041; H01S 3/23

(52) U.S. Cl. CPC H05G 2/008; H01S 3/2316; H01S 3/2366; H01S 3/2232; H01S 3/041
USPC 250/504 R

(57) ABSTRACT

A laser apparatus may include a master oscillator configured to output a laser beam, at least one amplifier provided in a beam path of the laser beam, at least one saturable absorber gas cell provided downstream from the at least one amplifier and configured to contain a saturable absorber gas for absorbing a part of the laser beam, the part of the laser beam having a beam intensity equal to or lower than a predetermined beam intensity, a fan provided in the saturable absorber gas cell and configured to cause the saturable absorber gas to circulate, and a heat exchanger provided in the saturable absorber gas cell and configured to cool the saturable absorber gas.

### CROSS-REFERENCE TO RELATED APPLICATION

The present application claims priority from Japanese Patent Application No. 2012-072588 filed Mar. 27, 2012.

### BACKGROUND

1. Technical Field

The present disclosure relates to laser apparatuses.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A laser apparatus according to one aspect of this disclosure may include a master oscillator configured to output a laser beam, at least one amplifier provided in a beam path of the laser beam, at least one saturable absorber gas cell provided downstream from the at least one amplifier and configured to contain a saturable absorber gas for absorbing a part of the laser beam, the part of the laser beam having a beam intensity equal to or lower than a predetermined beam intensity, a fan provided in the saturable absorber gas cell and configured to cause the saturable absorber gas to circulate, and a heat exchanger provided in the saturable absorber gas cell and configured to cool the saturable absorber gas.

### BRIEF DESCRIPTION OF THE DRAWINGS

Hereinafter, selected embodiments of the present disclosure will be described with reference to the accompanying drawings.

FIG. 1 schematically illustrates an exemplary configuration of an LPP type EUV light generation system.

FIG. 2 illustrates an example of a laser apparatus according to one embodiment of the present disclosure.

FIG. 3 illustrates an example of optical transmission properties of a saturable absorber gas.

FIG. 4A illustrates an example of beam intensity of a laser beam prior to passing through a saturable absorber gas cell.

FIG. 4B illustrates an example of beam intensity of a laser beam after passing through a saturable absorber gas cell.

FIG. 5A is a sectional view of a saturable absorber gas cell in a laser apparatus according to one embodiment of the present disclosure.

FIG. 5B is a sectional view of the saturable absorber gas cell shown in FIG. 5A, taken along VB-VB plane.

FIG. 6A is a sectional view illustrating an example of a saturable absorber gas cell according to a modification.

FIG. 6B is a sectional view of the saturable absorber gas cell shown in FIG. 6A, taken along VIB-VIB plane.

FIG. 7 illustrates an example of a saturable absorber gas cell system in a laser apparatus according to one embodiment of the present disclosure.

FIG. 8 illustrates an example of a slab amplifier in a laser apparatus according to one embodiment of the present disclosure.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein. Hereinafter, selected embodiments of the present disclosure will be described in detail with reference to the accompanying drawings. The embodiments of the present disclosure will be described following the table of contents below.

### Contents

### 1. Overview of EUV Light Generation System

### 1.1 Configuration

### 1.2 Operation

### 2. Laser Apparatus Including Optical Isolator

### 2.1 Configuration

### 2.2 Operation

### 2.3 Effect

### 3. Saturable Absorber Gas Cell

### 3.1 Configuration

### 3.2 Operation

### 3.3 Effect

### 3.4 Embodiments of Doublepass

### 3.5 Saturable Absorber Gas Cell System

4. Combining with Slab Amplifier

### 1. Overview of EUV Light Generation System

### 1.1 Configuration

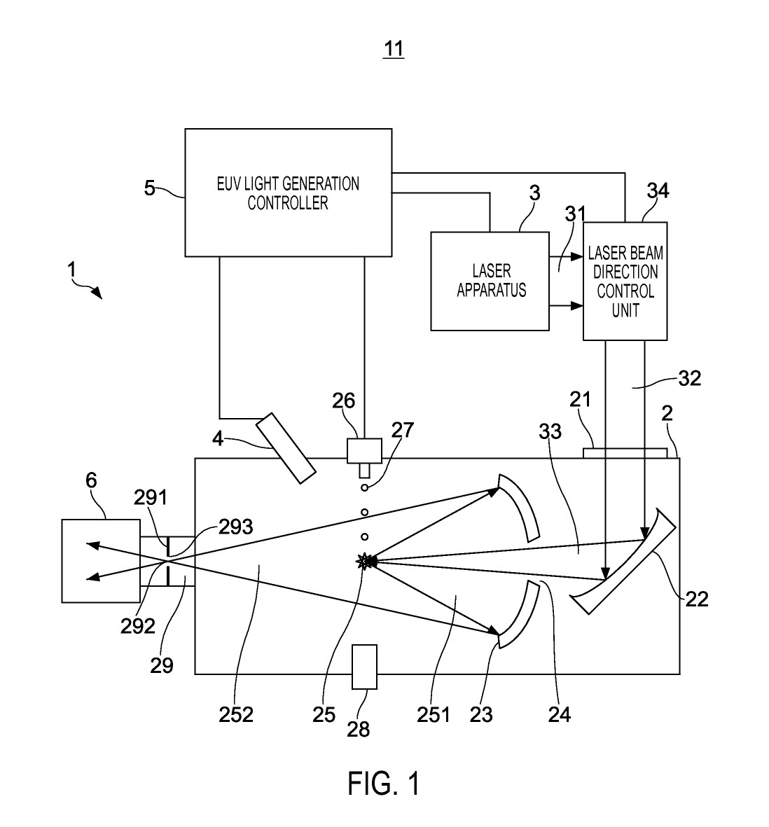

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture 293 may be provided in the connection part 29. The wall 291 may be positioned such that the second focus of the EUV collector mirror 23 lies in the aperture 293 formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 1.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 31 travels, and the position at which the pulse laser beam 33 is focused. It will be appreciated that the various controls mentioned above are merely examples, and other controls may be added as necessary.

### 2. Laser Apparatus Including Optical Isolator

### 2.1 Configuration

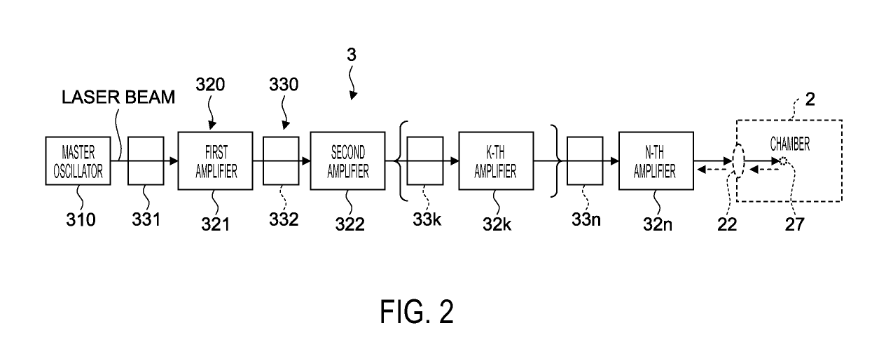

FIG. 2 illustrates an example of a laser apparatus according to one embodiment of the present disclosure. With reference to FIG. 2, a laser apparatus 3 according to this embodiment may include a master oscillator 310, at least one amplifier 320, and at least one optical isolator 330. The at least one amplifier 320 may include a plurality of amplifiers 321 through 32n. In FIG. 2, a first amplifier 321, a second amplifier 322, a k-th amplifier 32k, and an n-th amplifier 32n are illustrated. Similarly, the at least one optical isolator 330 may include a plurality of optical isolators 331 through 33n. In FIG. 2, a first optical isolator 331, a second optical isolator 332, a k-th optical isolator 33k, and an n-th optical isolator 33n are illustrated. Hereinafter, the reference numeral “320” may be used to collectively designate the amplifiers 321 through 32n. Similarly, the reference numeral “330” may be used to collectively designate the optical isolators 331 through 33n. Further, in FIG. 2, a chamber 2, a target 27, and a laser beam focusing optical system 22 described with reference to FIG. 1 are also illustrated as related constituent elements.

The amplifiers 321 through 32n and the optical isolators 331 through 33n may be provided in a beam path of a laser beam outputted from the master oscillator 310. The first optical isolator 331 may be provided downstream from the master oscillator 310. The second through n-th optical isolators 332 through 33n may be provided downstream from the amplifiers 321 through 32k, respectively. That is, the first optical isolator 331 may be provided between the master oscillator 310 and the first amplifier 321. Each of the second through n-th optical isolators 332 through 33n may be provided between the amplifiers 32k-1 and 32k. Here, k is a given natural number between 2 and n.

The master oscillator 310 may oscillate to output a laser beam in pulses at a predetermined repetition rate. The master oscillator 310 may be configured of any laser devices suitable for applications, and may, for example, be a laser device configured to oscillate in a bandwidth of a CO₂ laser medium.

An amplifier 320 may be provided to amplify the laser beam. Any suitable amplifiers may be used as the amplifier 320 depending on the applications. In this embodiment, for example, an amplifier 320 containing CO₂ gas as a gain medium may be used.

An optical isolator 330 may be provided to suppress a backpropagating beam from a target 27 and/or self-oscillation of an amplifier 320. In the laser apparatus 3 shown in FIG. 2, a saturable absorber gas cell may be used as at least one or more of the second through n-th optical isolators 332 through 33n provided downstream from the amplifiers 321 through 32k, respectively. Here, a saturable absorber gas cell or another type of optical isolator may be used as the first optical isolator 331. For example, an electro-optical (EO) Pockels cell in which an EO crystal formed of CdTe is held between electrodes and which functions as an optical isolator may be used as the first optical isolator 331.

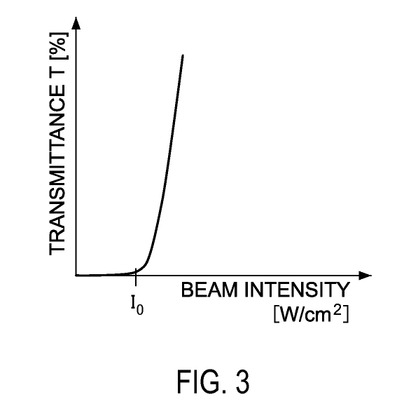

FIG. 3 illustrates an example of optical transmission properties of a saturable absorber gas. In FIG. 3, the horizontal axis shows beam intensity [W/cm²], and the vertical axis shows transmittance T [%]. As shown in FIG. 3, a saturable absorber gas may not transmit a laser beam having beam intensity equal to or lower than predetermined beam intensity I₀ and may transmit only a laser beam having beam intensity higher than the predetermined beam intensity Iₒ. A saturable absorber gas cell may be a cell in which a saturable absorber gas having the aforementioned optical transmission properties is contained. Such a gas cell may absorb a laser beam having beam intensity equal to or lower than the predetermined beam intensity I₀ and transmit a laser beam having beam intensity higher than the predetermined beam intensity I₀.

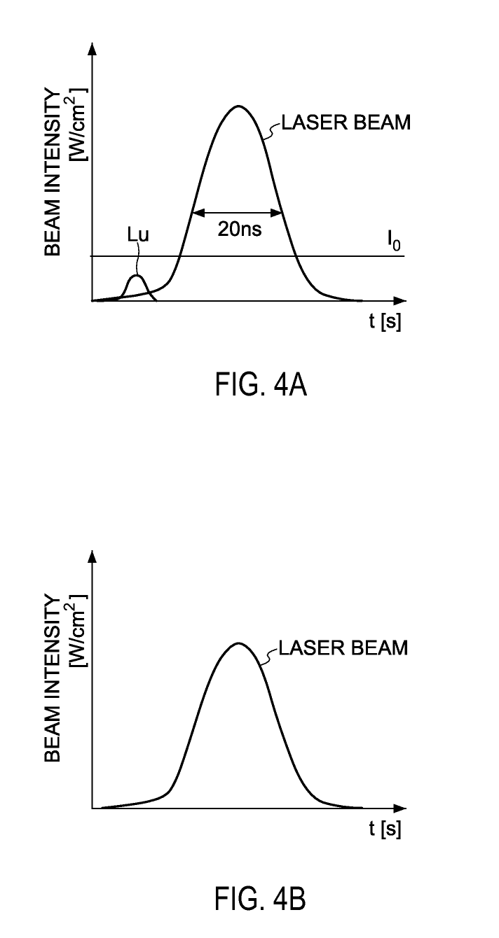

FIG. 4A illustrates an example of beam intensity of a laser beam prior to passing through a saturable absorber gas cell. In FIG. 4A, the horizontal axis shows time [S], and the vertical axis shows beam intensity [W/cm²]. FIG. 4A shows a case where an unwanted ray Lu resulting from a backpropagating beam or self-oscillation is added to the laser beam prior to passing through the saturable absorber gas cell. The saturable absorber gas contained in the saturable absorber gas cell in this case may have the optical transmission properties described above with reference to FIG. 3.

FIG. 4B illustrates an example of beam intensity of a laser beam after passing through a saturable absorber gas. As shown in FIG. 4B, upon passing through the saturable absorber gas cell, the beam intensity of the laser beam may be so changed that the unwanted ray Lu is substantially removed. In this way, the saturable absorber gas cell may absorb to remove a part of the laser beam which has beam intensity equal to or lower than the predetermined beam intensity I₀. Accordingly, a backpropagating beam or unwanted rays resulting from self-oscillation may be suppressed.

However, as the saturable absorber gas absorbs a laser beam, the temperature of the saturable absorber gas may rise. Accordingly, the saturable absorber gas may cease to exhibit the optical transmission properties shown in FIG. 3. Therefore, in the laser apparatus 3 according to one or more embodiments in the present disclosure, a configuration may be provided for suppressing a rise in temperature of the saturable absorber gas and ensuring the saturable absorber gas to function properly for an extended period of time. Details thereof will be described later.

### 2.2 Operation

Referring back to FIG. 2, an operation of the laser apparatus 3 shown in FIG. 2 will now be described.

First, the master oscillator 310 may oscillate at a predetermined repetition rate to output a laser beam in pulses. Further, power may be supplied to the amplifiers 320 from a power supply (not separately shown) while the laser beam passes through the amplifier 320. Power may also be supplied to the amplifier 320 even while the laser beam is not present in the amplifier 320 to cause an electric discharge to occur therein to pump the CO₂ laser gas.

The laser beam from the master oscillator 310 may pass through the first optical isolator 331. The laser beam from the first optical isolator 331 may then enter the first amplifier 321 and be amplified as the laser beam passes through the first amplifier 321.

The amplified laser beam from the first amplifier 321 may then pass through the second optical isolator 332. A backpropagating beam from a target 27 may be attenuated by the second optical isolator 322, and thus self-oscillation of the first amplifier 321 may be suppressed. Further, the laser beam from the second optical isolator 332 may then enter the second amplifier 322 and be further amplified as the laser beam passes through the second amplifier 322.

Similarly, the laser beam from a (k−1)-th amplifier 32k−1 (not separately shown) may pass through the k-th optical isolator 33k and enter the k-th amplifier 32k. Then, the laser beam may be further amplified as the laser beam passes through the k-th amplifier 32k. By repeating the above-described operation, the laser beam may be gradually amplified. A backpropagating beam from a target 27 may be attenuated by the k-th optical isolator 33k, and self-oscillation of the amplifier 32k−1 may be suppressed.

### 2.3 Effect

By using the optical isolator 330 configured as a saturable absorber gas cell, a part of the laser beam which has beam intensity higher than predetermined peak intensity may be transmitted with high transmittance. Accordingly, weak rays such as amplified spontaneous emission (ASE) light may be substantially absorbed and intense rays such as the laser beam from the master oscillator 310 and the amplified laser beam may be transmitted with high transmittance. Thus, amplification of ASE light generated in the amplifier 320 may be suppressed. Further, a backpropagating beam from a target 27 may be suppressed by the saturable absorber gas cell.

### 3. Saturable Absorber Gas Cell

### 3.1 Configuration

Subsequently, among the optical isolators 330 of the laser apparatus 3, one configured as a saturable absorber gas cell will be described in detail. In the laser apparatus 3, at least one optical isolator 330 provided downstream from an amplifier 320 may be configured as a saturable absorber gas cell. In this case, since the optical isolator 330 and the saturable absorber gas cell are identical, the same reference numeral is used to refer to the saturable absorber gas cell 330.

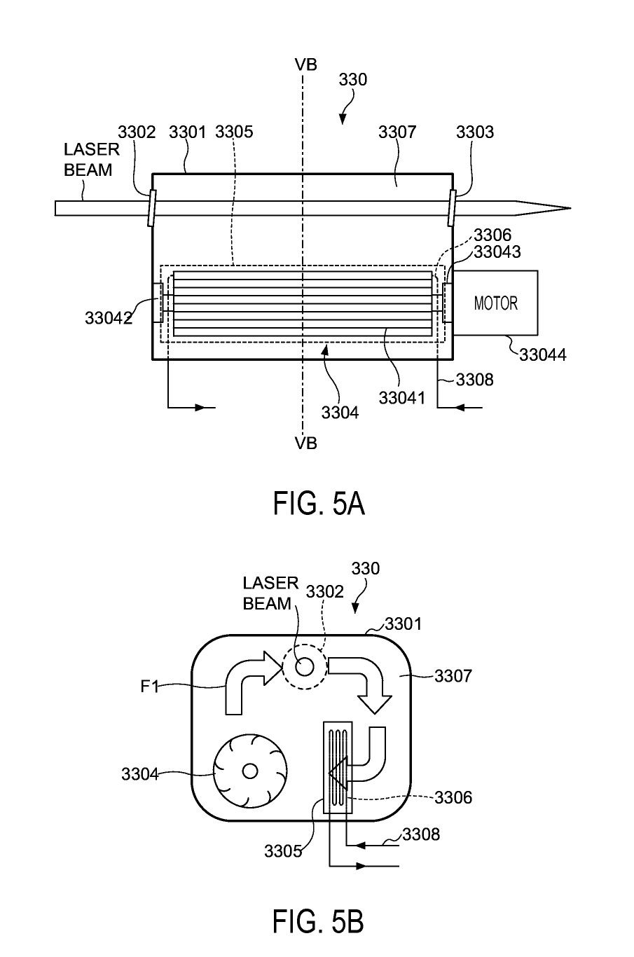

FIG. 5A is a sectional view of a saturable absorber gas cell in a laser apparatus according to one embodiment of the present disclosure. FIG. 5B is a sectional view of the saturable absorber gas cell shown in FIG. 5A, taken along VB-VB plane.

In FIGS. 5A and 5B, the saturable absorber gas cell 330 may include a chamber 3301, an input window 3302, an output window 3303, a fan 3304, and a heat exchanger 3305. The fan 3304 may include a rotor 33041, bearings 33042 and 33043, and a motor 33044. The heat exchanger 3305 may include a flow channel 3306 formed thereinside, and the flow channel 3306 may be connected to an external cooling pipe 3308. Further, the chamber 3301 may be filled with a saturable absorber gas 3307. Although the saturable absorber gas 3307 is not depicted as an entity, it is assumed that the chamber 3301 is filled with the saturable absorber gas 3307. This point is also applicable in the description to follow.

The input window 3302 and the output window 3303 may be provided on side surfaces of the chamber 3301 such that the laser beam enters the chamber 3301 through the input window 3302 and is outputted therefrom through the output window 3303. The fan 3304 may be provided to follow along the beam path of the laser beam in a region aside from the beam path. The heat exchanger 3305 may also be provided to follow along the beam path of the laser beam in a region aside from the beam path. Thus, a circulation path of the saturable absorber gas 3307 generated by the fan 3304 may be made substantially perpendicular to the beam path of the laser beam.

The chamber 3301 may serve as a processing chamber that houses the fan 3304 and the heat exchanger 3305. The shape of the chamber 3301 is not particularly limited and may be configured in any suitable shape in accordance with the beam profile of the laser beam and/or the applications. The chamber 3301 may, for example, be configured into a shape close to a parallelepiped that is capable of housing the fan 3304 and the heat exchanger 3305 thereinside. Although the corners of the chamber 3301 are rounded in FIG. 5B, the chamber 3301 having a substantially parallelepiped may be used.

The input window 3302 may be a window through which the laser beam enters the chamber 3301. The output window 3303 may be a window through which the laser beam that has passed through the chamber 3301 is outputted. The input window 3302 and the output window 3303 may be provided such that a line connecting the respective windows 3302 and 3303 is substantially perpendicular to the circulation path of the saturable absorber gas 3307.

Each of the input window 3302 and the output window 3303 may be formed of any one of diamond, ZnSe, and GaAs that transmit a CO₂ laser beam. Preferably, a diamond window having high thermal conductivity may be used as the input window 3302 and the output window 3303.

The fan 3304 may be provided inside the chamber 3301 to cause the saturable absorber gas 3307 to circulate. Thus, the saturable absorber gas 3307 may be made to circulate inside the chamber 3301 directly and efficiently.

The fan 3304 may have such a configuration that two ends of a rotation shaft of the rotor 33041 are rotatably supported by the respective bearings 33042 and 33043 and the rotation shaft is rotated by the motor 33044. As each of the bearings 33042 and 33043, a magnetic bearing may, for example, be used, and the rotation shaft of the rotor 33041 may be supported without making contact with the bearings 33042 and 33043.

The fan 3304 may be provided such that the rotation shaft of the rotor 33041 is substantially parallel to the beam path of the laser beam. As the rotor 33041 rotates, a circulation flow F1 of the saturable absorber gas 3307 may be formed in a direction perpendicular to the beam path of the laser beam.

As the fan 3304, any suitable fans may be used as long as a given fan is capable of causing the saturable absorber gas 3307 to circulate inside the chamber 3301. For example, the fan 3304 may be a cross flow fan or a sirocco fan, or may be configured by arranging a plurality of axial flow fans.

The heat exchanger 3305 may be provided to cool the saturable absorber gas 3307 inside the chamber 3301. More specifically, the heat exchanger 3305 may be provided in the circulation flow F1 of the saturable absorber gas 3307 generated by the fan 3304 to cool the saturable absorber gas 3307 that comes in contact with the heat exchanger 3305. The saturable absorber gas 3307 may absorb a laser beam having beam intensity equal to or lower than a predetermined peak value with high absorptance, and in turn the temperature of the saturable absorber gas 3307 may rise by absorbing the laser beam. When the temperature of the saturable absorber gas 3307 rises, a nonuniform distribution of the refractive index of the saturable absorber gas 3307 may occur, and the wavefront of the laser beam outputted from the saturable absorber gas cell 330 may deform. Thus, the heat exchanger 3305 may cool the saturable absorber gas 3307 in order to suppress the deformation of the laser beam. By providing the fan 3304 and the heat exchanger 3305 inside the chamber 3301 of the saturable absorber gas cell 330, the saturable absorber gas 3307 may be made to circulate efficiently, and the saturable absorber gas 3307 may be cooled directly with the heat exchanger 3305. Accordingly, the cooling effect of the saturable absorber gas 3307 may be increased.

A flow channel 3306 may be formed in the heat exchanger 3305 to allow a cooling medium to flow therein, and the flow channel 3306 may be connected to an external cooling pipe 3308. The cooling medium such as cooling water may flow in the cooling pipe 3308 and the flow channel 3306 to cool the heat exchanger 3305.

A type of gas to be used as the saturable absorber gas 3307 is not particularly limited, and various types of gas may be used as long as the given gas has such properties that a laser beam having a beam intensity equal to or lower than a predetermined peak intensity is absorbed and is not transmitted. For example, when a bandwidth of the laser beam is 10.6 μm, gas containing at least one of SF₆, N₂F₄, PF₅, BCl₃, CH₃CHF₂, and high-temperature CO₂ may be used. Further, when a bandwidth of the laser beam is 9.6 μm, gas containing at least one of CH₃OH, CH₃F, HCOOH, CD₃OD, CD₃F, and DCOOD, where D is deuterium, may be used. Furthermore, when a bandwidth of the laser beam is 9.6 μm, gas containing C₂F₃Cl may also be used.

Here, gas in the saturable absorber gas cell 330 may include, aside from the aforementioned gases, N₂ or He gas as a buffer gas.

Further, when CO₂ is used as the saturable absorber gas 3308, CO₂ gas at a temperature of approximately 400° C. may, for example, be used.

### 3.2 Operation

First, an assumption is that a laser beam to enter the saturable absorber gas cell 330 is a sheet laser beam generated through any suitable method. For example, the laser beam may be a sheet laser beam outputted from a slab amplifier to be described later. Alternatively, the sheet laser beam may be generated from a circular laser beam using a cylindrical mirror.

As a specific operation, a sheet laser beam may be transmitted through the input window 3302 to enter the chamber 3301, pass through the circulation flow F1 of the saturable absorber gas 3307 generated by the fan 3304, and be transmitted through the output window 3303 to be outputted from the chamber 3301.

When the laser beam passes through the circulation flow F1 of the saturable absorber gas 3307, a part of the laser beam having a beam intensity equal to or lower than a predetermined beam intensity may be absorbed by the saturable absorber gas 3307. Heat generated as the saturable absorber gas 3307 absorbs a part of the laser beam may be dissipated by the heat exchanger 3305 provided in the circulation flow F1 of the saturable absorber gas 3307. Thus, even if the saturable absorber gas 3307 absorbs the laser beam continuously, the above-described properties of the saturable absorber gas 3307 may be retained.

### 3.3 Effect

With the above-described laser apparatus 3, the circulation direction of the saturable absorber gas 3307 may be substantially perpendicular to the beam path of the laser beam traveling through the saturable absorber gas cell 330, and the heat exchanger 3305 may be provided within the circulation flow F1. Accordingly, a rise in temperature of the saturable absorber gas 3307 may be suppressed efficiently. Further, the chamber 3301 may be extended in the direction of the axis of the laser beam path, and thus the beam path passing through the saturable absorber gas 3307 may be extended. As a result, even when the concentration of the saturable absorber gas 3307 is kept low and the absorption of the laser beam per unit length along the beam path is small, since the beam path of the laser beam passing through the saturable absorber gas 3307 is long, the saturable absorbing properties may be retained. Further, since the absorption of the laser beam per unit length along the beam path is small, a rise in temperature of the saturable absorber gas 3307 may be suppressed.

### 3.4 Embodiments of Doublepass: Modification

Subsequently, a saturable absorber gas cell 3330 that differs from the saturable absorber gas cell 330 will be described as a modification.

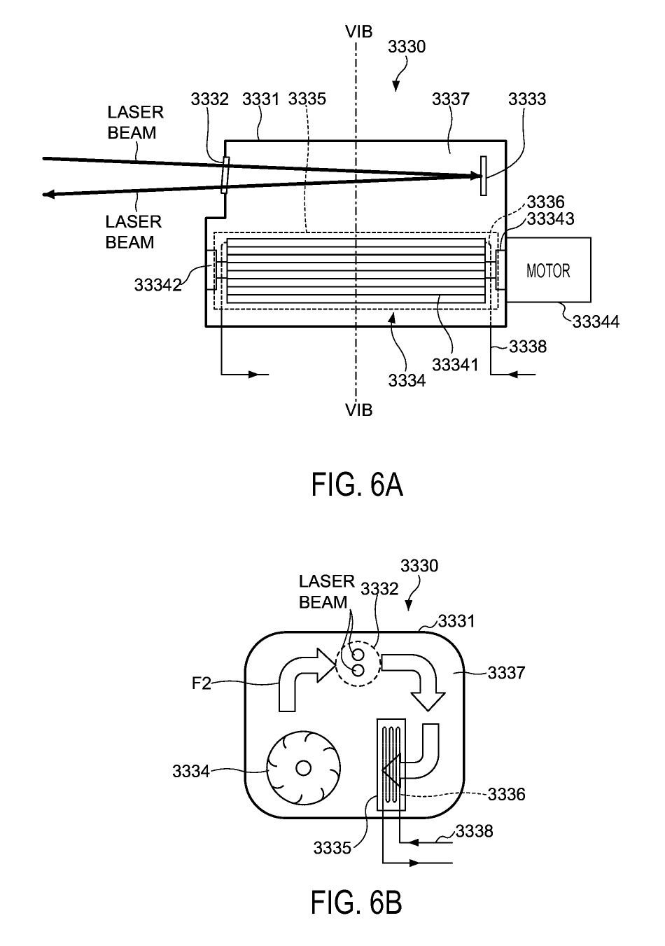

FIG. 6A is a sectional view illustrating an example of a saturable absorber gas cell according to a modification. FIG. 6B is a sectional view of the saturable absorber gas cell shown in FIG. 6A, taken along VIB-VIB plane.

With reference to FIGS. 6A and 6B, the saturable absorber gas cell 3330 of the modification may include a chamber 3331, a window 3332, a reflective mirror 3333, a fan 3334, a heat exchanger 3335, and a saturable absorber gas 3337. The fan 3334 may include a rotor 33341, bearings 33342 and 33343, and a motor 33344. The heat exchanger 3335 may include a flow channel 3336 formed thereinside. A cooling pipe 3338 connected to the flow channel 3336 may be provided outside the saturable absorber gas cell 3330.

In the saturable absorber gas cell 3330, the chamber 3331, the window 3332, the fan 3334, and the heat exchanger 3335 may have similar configurations and functions to those in the saturable absorber gas cell 330, and thus the description thereof will be omitted.

The saturable absorber gas cell 3330 may differ from the saturable absorber gas cell 330 shown in FIGS. 5A and 5B in that the saturable absorber gas cell 3330 includes the high-reflection mirror 3333 in the chamber 3331. The high-reflection mirror 3333 may be provided to face the window 3332 so that the entering laser beam may be reflected by the high-reflection mirror 3333. Further, the window 3332 may differ from the input window 3302 of the saturable absorber gas cell 330 in that the laser beam reflected by the high-reflection mirror 3333 is also outputted through the window 3332.

As shown in FIG. 6A, the laser beam that has entered the saturable absorber gas cell 3330 through the window 3332 may be reflected by the high-reflection mirror 3333 and be outputted through the window 3332. That is, a doublepass may be formed along which the laser beam travels twice through the saturable absorber gas 3337. As the pulse laser beam travels back and forth between the high-reflection mirror 3333 and the window 3332, the beam path of the laser beam in the saturable absorber gas cell 3330 may be doubled. That is, a distance in which the laser beam travels through the saturable absorber gas 3337 may be doubled. Thus, even when the concentration of the saturable absorber gas 3337 is kept low and the absorption of the laser beam per unit length along the beam path is small, since the beam path of the laser beam passing through the saturable absorber gas 3337 is long, the saturable absorbing properties of the saturable absorber gas 3337 may be retained. Further, since the absorption of the laser beam per unit length along the beam path is small, a rise in temperature of the saturable absorber gas 3337 may be suppressed.

As described above, in the saturable absorber gas cell 3330, an optical system in which the laser beam makes a doublepass by the high-reflection mirror 3333 is employed. Thus, the fan 3334 may be configured to form a circulation flow F2 to cover the beam path in which the laser beam makes a doublepass. As shown in FIG. 6B, the window 3332 may be provided so that the laser beam passes through the circulation flow F2 in the saturable absorber gas 3337, and the heat exchanger 3335 may be provided in the circulation flow F2. In this regard, the saturable absorber gas cell 3330 may be the same as the saturable absorber gas cell 330 shown in FIGS. 5A and 5B. Thus, the saturable absorber gas 3337 may be cooled along the entire beam path of the doublepass.

### 3.5 Saturable Absorber Gas Cell System

Subsequently, an example where a laser apparatus is configured to include a saturable absorber gas cell system that includes the saturable absorber gas cell 330 shown in FIGS. 5A and 5B will be described.

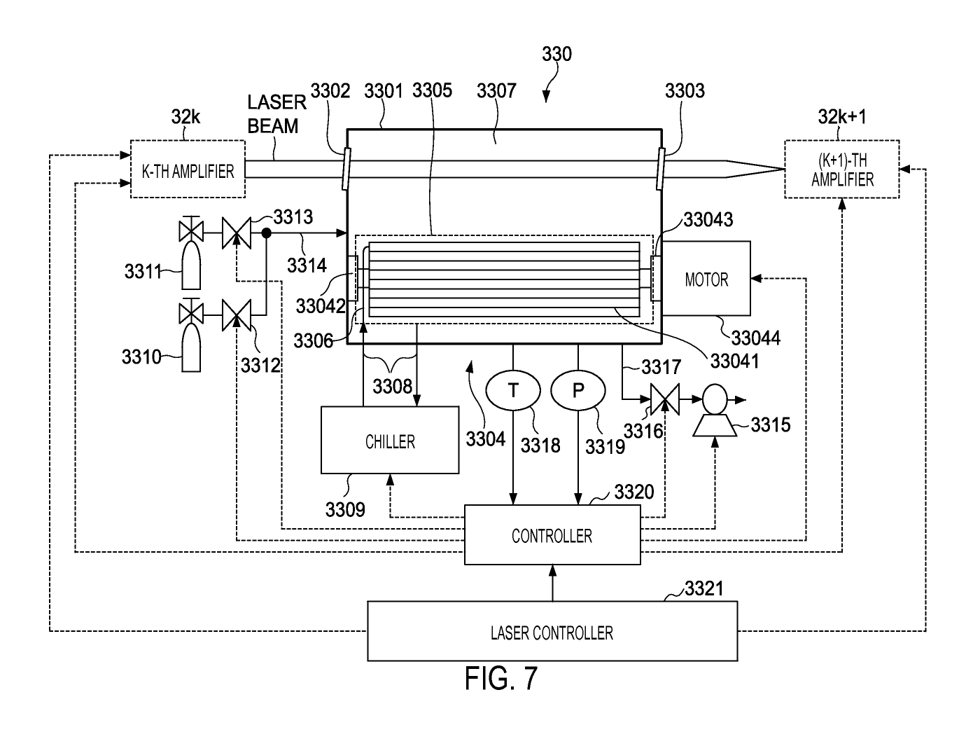

FIG. 7 illustrates an example of a saturable absorber gas cell system in a laser apparatus according to one embodiment of the present disclosure. In the saturable absorber gas cell system shown in FIG. 7, the saturable absorber gas cell 330 shown in FIGS. 5A and 5B is employed, and thus the description of the configuration of the saturable absorber gas cell 330 will be omitted.

The saturable absorber gas cell system shown in FIG. 7 may include, aside from the saturable absorber gas cell 330, a cooling pipe 3308, a chiller 3309, a saturable absorber gas tank 3310, a buffer tank 3311, valves 3312 and 3313, a gas supply pipe 3314, an exhaust pump 3315, a valve 3316, a discharge pipe 3317, a temperature sensor 3318, a pressure sensor 3319, and a controller 3320. The controller 3320 may be controlled by a laser controller 3321.

The k-th amplifier 32k, the saturable absorber gas cell 330, and a (k+1)-th amplifier 32k+1 may be provided in a beam path of the laser beam. The saturable absorber gas cell 330 may be provided between the k-th amplifier 32k and the (k+1)-th amplifier 32k+1.

The flow channel 3306 formed in the heat exchanger 3305 may be connected to the external cooling pipe 3308, and the cooling pipe 3308 may be connected to the chiller 3309. That is, the cooling medium such as cooling water may be supplied into the flow channel 3306 from the chiller 3309 through the cooling pipe 3308.

The saturable absorber gas tank 3310 may be connected to the gas supply pipe 3314 through the valve 3312, and the buffer tank 3311 may be connected to the gas supply pipe 3314 through the valve 3313. The gas supply pipe 3314 may be connected to the chamber 3301 of the saturable absorber gas cell 330 so that the saturable absorber gas and the buffer gas are supplied into the chamber 3301.

The exhaust pump 3315 may be connected to the discharge pipe 3317 through the valve 3316. The discharge pipe 3317 may be connected to the chamber 3301, and the interior of the chamber 3301 may be exhausted by the exhaust pump 3315.

The temperature sensor 3318 and the pressure sensor 3319 may be connected to the chamber 3301 and also communicably connected to the controller 3320. The controller 3320 may be capable of receiving detection signals from the temperature sensor 3318 and the pressure sensor 3319. The controller 3320 may further be communicably connected to the chiller 3309 and the valves 3312, 3313, and 3316. The laser controller 3321 may be communicably connected to the amplifiers 32k and 32k+1 and the controller 3320.

Subsequently, individual constituent elements will be described.

The chiller 3309 may cause the cooling medium to circulate while monitoring the temperature of the cooling medium supplied to the heat exchanger 3305. More specifically, the cooling medium supplied from the chiller 3309 may flow through the flow channel 3306 in the heat exchanger 3305 through the cooling pipe 3308 to cool the saturable absorber gas 3307, and return to the chiller 3309 through the cooling pipe 3308. The cooling medium may be cooling water or may be a heat carrier aside from the cooling water.

Here, when CO₂ gas is used as the saturable absorber gas 3307 and needs to be heated, the following can be carried out. For example, oil may be used as a heat carrier flowing in the heat exchanger 3305, and the chiller 3309 may be configured to heat and cool the oil. Alternatively, a heating unit such as a heater may be provided on the heat exchanger 3305. In this case, depending on the operation state of the laser apparatus 3, the CO₂ gas may be heated or cooled. More specifically, when the laser apparatus 3 is started or when an output thereof is small, the CO₂ gas may be heated. On the other hand, when an output of the laser apparatus 3 reaches or exceeds a predetermined level, the CO₂ gas needs to be cooled since the temperature may rise excessively from heat generated as the CO₂ gas absorbs the laser beam. Then, the chiller 3309 may cool the cooling medium.

The saturable absorber gas tank 3310 may be a saturable absorber gas supply source. The saturable absorber gas tank 3310 may contain any of the various saturable absorber gases cited above in the description of the saturable absorber gas cell 330 shown in FIGS. 5A and 5B. The valve 3312 may adjust an amount of the saturable absorber gas supplied from the saturable absorber gas tank 3310 into the chamber 3301 in accordance with an instruction from the controller 3321. In the present embodiment, an example where the saturable absorber gas tank 3310 contains SF₆ will be described.

The buffer gas tank 3311 may be a buffer gas supply source. The buffer gas tank 3311 may, for example, contain an inert gas such as N₂ or He. When the concentration of the saturable absorber gas 3307 in the chamber 3301 is excessively high, the absorption of the laser beam becomes excessively high. In that case, the buffer gas may be supplied to adjust the concentration of the saturable absorber gas 3307 in the chamber 3301. A supply amount of the buffer gas may be controlled by adjusting the opening of the valve 3313 in accordance with an instruction from the controller 3320. In the present embodiment, an example where N₂ gas is used as the buffer gas will be described.

The exhaust pump 3315 may discharge gas inside the chamber 3301 through the discharge pipe 3317. A discharge amount from the exhaust pump 3315 may be adjusted by the opening of the valve 3316 being controlled through an instruction from the controller 3320.

The temperature sensor 3318 may detect a temperature inside the chamber 3301. The pressure sensor 3319 may detect a pressure inside the chamber 3301. Sensing stations of the temperature sensor 3318 and the pressure sensor 3319, respectively, may, for example, be provided inside the chamber 3301, and a detection result of each of the temperature sensor 3318 and the pressure sensor 3319 may be outputted to the controller 3320. The controller 3320 may in turn carry out various controls in accordance with received detection results.

The controller 3320 may control the chiller 3309 and the valves 3312, 3313, and 3316 based on a detected temperature and a detected pressure inside the chamber 3301. Thus, a temperature and a flow rate of a cooling medium circulating in the flow channel 3306, a supply amount of the saturable absorber gas and the buffer gas, and a discharge amount of gas from the chamber 3301 may be controlled, and the saturable absorber gas cell system may be driven in an optimal state. Here, for carrying out the control operations described above, the controller 3320 may include a central processing unit (CPU), a microcomputer that operates by loading a program, and an application specific integrated circuit (ASIC).

Here, when CO₂ is used as the saturable absorber gas 3307, the controller may, for example, control the temperature of the CO₂ gas to approximately 400° C. In this case, the temperature of the CO₂ gas may be controlled to a predetermined temperature of approximately 400° C. based on a detection result of the temperature sensor 3318.

The laser controller 3321 may control the amplifiers 32k and 32k+1 and the saturable absorber gas cell 330. The laser controller 3321 may send an instruction to the controller 3320 to control the saturable absorber gas cell 330.

An operation of the saturable absorber gas cell system having the above-described configuration will now be described.

The controller 3320 may first drive the exhaust pump 3315 and open the valve 3316 to discharge gas from the chamber 3301. Then, when a pressure measured by the pressure sensor 3319 falls to or below a predetermined value and the chamber 3301 reaches a near vacuum state, the controller 3320 may close the valve 3316.

Subsequently, the controller 3320 may open the valves 3312 and 3313 to introduce SF₆ gas and N₂ gas into the chamber 3301. Then, when a value detected by the pressure sensor 3319 reaches a predetermined value such as a predetermined partial pressure of the SF₆ gas, the controller 3320 may close the valves 3312 and 3313.

Thereafter, the controller 3320 may send a signal to the chiller 3309 to allow the cooling medium to circulate. The controller 3320 may control a temperature of the cooling medium using the chiller 3309 so that a value to be detected by the temperature sensor reaches a predetermined value.

The controller 3320 may send a signal to the laser controller 3321 to inform that the saturable absorber gas cell 330 has been started up.

Thereafter, upon receiving a signal from the controller 3320, the laser controller 3321 may drive the master oscillator 310 and the amplifiers 321 through 32n shown in FIG. 2.

During this time, the controller 3320 may keep monitoring the pressure and the temperature inside the chamber 3301. When the pressure and the temperature fall out of predetermined ranges, respectively, the controller 3320 may send an error signal to the laser controller 3321. When the laser controller 3321 receives an error signal, the laser controller 3321 may cause the laser apparatus 3 to stop outputting a laser beam.

When the pressure and the temperature inside the chamber 3301 fall within predetermined ranges, respectively, the operation may be continued, and the controller 3320 may keep monitoring the pressure and the temperature inside the chamber 3301.

As described above, according to the laser apparatus that includes the saturable absorber gas cell system shown in FIG. 7, the temperature and the pressure inside the saturable absorber gas cell 330 may be monitored, and when an error occurs, an output of a laser beam is stopped. Accordingly, the laser apparatus may be operated with high reliability.

Further, although an example where the saturable absorber gas cell 330 shown in FIGS. 5A and 5B is used is described with reference to FIG. 7, this disclosure is not limited thereto, and a laser apparatus may be configured to include the saturable absorber gas cell 3310 of the modification described above.

4. Combining with Slab Amplifier

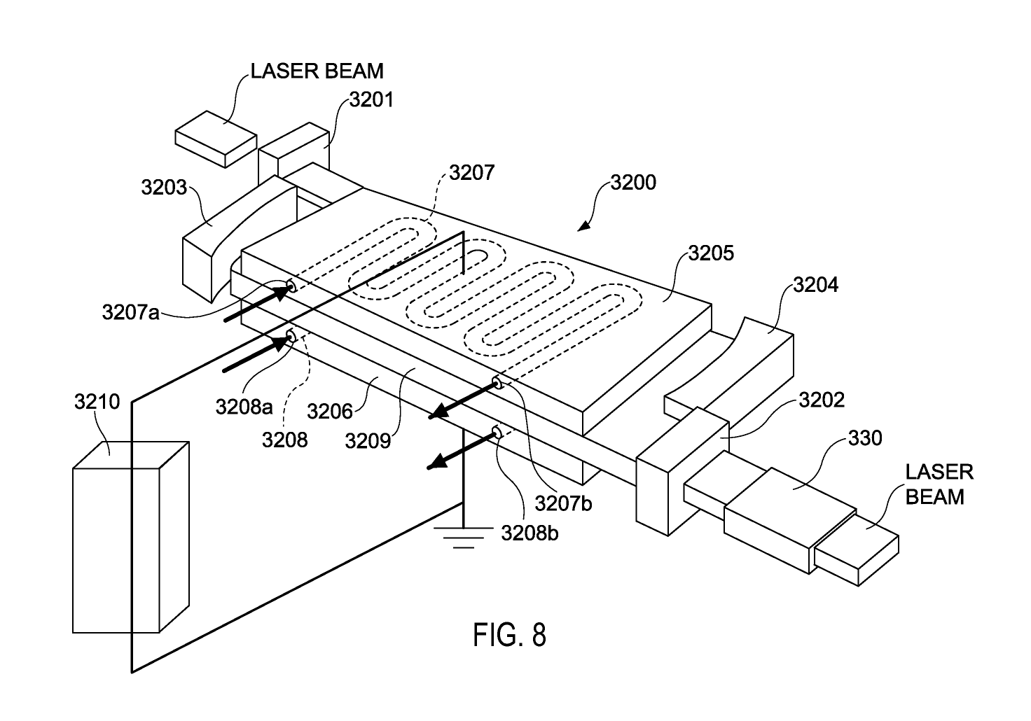

FIG. 8 illustrates an example of a slab amplifier in a laser apparatus according to one embodiment of the present disclosure. Hereinafter, an example where an amplifier 320 is configured as a slab amplifier 3200 and where the slab saturable absorber gas cell 330 shown in FIGS. 5A and 5B is provided downstream from the slab amplifier 3200 will be described.

The slab amplifier 3200 may include an input window 3201, an output window 3202, a pair of high-reflection concave mirrors 3203 and 3204, a pair of electrodes 3205 and 3206, and a radio frequency (RF) power supply 3210. Flow channels 3207 and 3208 may be formed inside the respective electrodes 3205 and 3206, and the flow channels 3207 and 3208 may include inlets 3207a and 3208a and outlets 3207b and 3208b, respectively. Further, a space to serve as a discharge region 3209 may be configured between the electrodes 3205 and 3206. Here, a laser chamber (not separately shown) may be provided to house the electrodes 3205 and 3206.

The high-reflection concave mirrors 3203 and 3204 may be provided to face each other with the discharge region 3209 located therebetween. A laser beam reflected by the high-reflection concave mirrors 3203 and 3204 may make a multipass within the discharge region 3209 secured between the electrodes 3205 and 3206.

The electrode 3205 and the electrode 3206 may be provided to face each other, and the discharge region 3209 secured therebetween may be filled with a gaseous gain medium. A CO₂ laser gas may, for example, be used as the gain medium. A cooling medium such as cooling water may flow into the flow channels 3207 and 3208 formed inside the electrodes 3205 and 3206 through the inlets 3207a and 3208a and flow out through the outlets 3207b and 3208b. The RF power supply 3210 may be connected to the electrodes 3205 and 3206 to apply a high frequency voltage therebetween. Here, the electrode 3205 may be connected to a high potential side of the RF power supply 3210, and the electrode 3206 may be connected to a low potential side of the RF power supply 3210 and may also be grounded.

In the slab amplifier 3200 configured as described above, a laser beam may enter the aforementioned laser gas chamber (not separately shown) filled with a gain medium, such as a CO₂ laser gas, through the input window 3201. Then, a high frequency voltage may be applied between the flat electrodes 3205 and 3206, and thus a discharge may occur in the discharge region 3209. As the laser beam is reflected by the pair of high-reflection concave mirrors 3203 and 3204 to form a multipass in the discharge region 3209, the laser beam may be amplified, and the amplified laser beam may be outputted from the laser gas chamber through the output window 3202.

Here, an optical system forming a multipass in the discharge region 3209 may be a conjugate optical system in which an image of the input laser beam is transferred onto the output laser beam.

Further, the laser beam in this example may be a sheet laser beam elongated in a direction perpendicular to the discharge direction in the discharge region 3209.

As described above, the slab saturable absorber gas cell 330 may be provided to serve as an optical isolator in a beam path downstream from the slab amplifier 3200.

Here, although an example where the saturable absorber gas cell 330 shown in FIGS. 5A and 5B is provided downstream from the slab amplifier 3200 is described with reference to FIG. 8, the present disclosure is not limited thereto, and the saturable absorber gas cell 3330 of the modification may be provided downstream from the slab amplifier 3200 as well.

The saturable absorber gas cell according to any one of the present embodiments and the modification described above may be provided at a downstream side inside the laser apparatus, but may also be provided at an upstream side inside the laser apparatus. Thus, the saturable absorber gas cell described above may be used as the first optical isolator 331 (see FIG. 2) immediately downstream from the master oscillator 310, or as any one of the other optical isolators 332 through 33n.

The above-described examples and the modifications thereof are merely examples for implementing the present disclosure, and the present disclosure is not limited thereto. Making various modifications according to the specifications or the like is within the scope of the present disclosure, and other various examples are possible within the scope of the present disclosure. For example, the modifications illustrated for particular ones of the examples can be applied to other examples as well (including the other examples described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A laser apparatus, comprising:
a master oscillator configured to output a laser beam;
at least one amplifier provided in a beam path of the laser beam;
at least one saturable absorber gas cell provided downstream from the at least one amplifier and configured to contain a saturable absorber gas for absorbing a part of the laser beam, the part of the laser beam having a beam intensity equal to or lower than a predetermined beam intensity;
a fan provided in the saturable absorber gas cell and configured to cause the saturable absorber gas to circulate; and
a heat exchanger provided in the saturable absorber gas cell and configured to cool the saturable absorber gas.

2. The laser apparatus according to claim 1, wherein the fan is provided such that a rotation shaft thereof is substantially parallel to a beam path of the laser beam and such that a circulation flow of the saturable absorber gas generated by the fan is contained in the beam path of the laser beam.

3. The laser apparatus according to claim 2, wherein the heat exchanger extends substantially parallel to the beam path of the laser beam and is arranged in the circulation flow of the saturable absorber gas generated by the fan.

4. The laser apparatus according to claim 3, wherein the fan is a cross flow fan.

5. The laser apparatus according to claim 1, wherein the saturable absorber gas cell is further provided downstream from the master oscillator in the beam path of the laser beam.

6. The laser apparatus according to claim 1, further comprising a Pockels cell provided downstream from the master oscillator to function as an optical isolator, the Pockels cell being configured of electrodes sandwiching an electro-optical crystal formed of CdTe.

7. The laser apparatus according to claim 1, wherein the saturable absorber gas cell contains at least one of SF₆, N₂F₄, PF₅, BCl₃, CH₃CHF₂, CO₂, CH₃OH, CH₃F, HCOOH, CD₃OD, CD₃F, DCOOD, and C₂F₃Cl.
